(19) United States
(12) Patent Application Publication
(10) Pub. No.: US 2014/0176891 A1
(43) Pub. Date: Jun. 26, 2014

(54) LIQUID CRYSTAL DISPLAY PANEL

(71) Applicants: Yuhko Hisada, Osaka-shi (JP); Katsushige Asada, Osaka-shi (JP); Tetsuya Fujikawa, Osaka-shi (JP); Akihiro Shohraku, Osaka-shi (JP); Yuki Yamashita, Osaka-shi (JP)

(72) Inventors: Yuhko Hisada, Osaka-shi (JP); Katsushige Asada, Osaka-shi (JP); Tetsuya Fujikawa, Osaka-shi (JP); Akihiro Shohraku, Osaka-shi (JP); Yuki Yamashita, Osaka-shi (JP)

(73) Assignee: SHARP KABUSHIKI KAISHA, Osaka-shi, Osaka (JP)

(21) Appl. No.: 14/236,421

(22) PCT Filed: Aug. 3, 2012
(86) PCT No.: PCT/JP2012/069789

§ 371 Date: Jan. 31, 2014

(30) Foreign Application Priority Data
Aug. 10, 2011 (JP) 2011-175464

(51) Int. Cl. G02F 1/1343

(52) U.S. Cl. CPC G02F 1/13439
USPC 349/139

(57) ABSTRACT

The present invention provides a liquid crystal display panel which facilitates laser repair for repairing defects even if an electrode facing a pixel electrode with an insulating film therebetween is a transparent electrode. The liquid crystal display panel of the present invention includes a first substrate having an insulating substrate, a thin film transistor, a scan signal line, a first light-shielding electrode, a first insulating film, a second light-shielding electrode, a second insulating film, a transparent electrode, a third insulating film, and a pixel electrode; a second substrate having an insulating substrate; and a liquid crystal layer sandwiched between the first substrate and the second substrate. The second light-shielding electrode is located between the thin film transistor and the pixel electrode and connected to the pixel electrode through a connecting portion formed through the second insulating film and the third insulating film. The first light-shielding electrode at least partly overlaps with the second light-shielding electrode through the first insulating film. The transparent electrode is in a layer closer to the liquid crystal layer than both a layer including the scan signal line and a layer including the second light-shielding electrode are.

### TECHNICAL FIELD

The present invention relates to a liquid crystal display panel. Specifically, the present invention relates to a liquid crystal display panel including a substrate having electrodes in different layers separated by an insulating film.

### BACKGROUND ART

Liquid crystal display (LCD) panels are devices controlling light transmission/shutoff (turning on/turning off of display) by controlling the alignment of liquid crystal molecules having birefringence. Liquid crystal alignment modes of the LCD include twisted nematic (TN) mode, in which the liquid crystal molecules having positive dielectric constant anisotropy are twisted 90° in the normal direction of the substrate; vertical alignment (VA) mode, in which the liquid crystal molecules having negative dielectric constant anisotropy are aligned perpendicular to the substrate surface; in-plane switching (IPS) mode, in which the liquid crystal molecules having positive or negative dielectric constant anisotropy are aligned horizontally to the substrate surface so that a transverse electric field can be applied to the liquid crystal layer; and fringe field switching (FFS) mode (see Patent Literature 1, for example).

A widely spread driving system of the LCD panel is an active matrix driving system, in which an active element such as a thin film transistor (TFT) is installed for each pixel to realize high image quality. LCD panels equipped with TFTs include one including an active matrix substrate in which a plurality of scan signal lines and a plurality of data signal lines intersect each other, and each of the intersections of the lines have a TFT and a pixel electrode (see Patent Literature 2, for example). Typical LCD panels are further equipped with a common electrode on the active matrix substrate or a counter substrate. Through this pair of electrodes, a voltage is applied to the liquid crystal layer.

The active matrix substrate in the LCD panel may include, for example, a glass substrate, conductive parts such as scan signal lines, data signal lines, and TFTs formed on the glass substrate, a transparent electrode formed on the conductive parts with a first insulating film therebetween, and pixel electrodes formed on the transparent electrode with a second insulating film therebetween (see Patent Literatures 3 and 4, for example). In this case, each pixel electrode is connected to the drain electrode of the corresponding TFT through a contacting hole formed through the first and second insulating films. Each TFT has a semiconductor layer, a gate electrode, a source electrode, and a drain electrode. The gate electrode, the source electrode, and drain electrode are connected to, respectively, the corresponding scan signal line, data signal line, and pixel electrode. When the TFT is turned on, current flows from the data signal line to the drain electrode, so that the pixel electrode and the common electrode that is on the counter substrate can generate liquid crystal capacity Clc in the liquid crystal layer. Thus, the alignment of the liquid crystal molecules is changed by switching voltage on and off, enabling control of switching on and off of liquid crystal display. In the active matrix substrate with such a structure, an auxiliary capacity can be formed between the transparent electrode and the pixel electrode. This auxiliary capacitance stabilizes the liquid crystal capacity Clc formed by the pixel electrode and the common electrode on the counter substrate during the period between a switch off and the subsequent switch on of the TFT. In addition, since the electrode for forming the auxiliary capacitance is a transparent electrode, pixels having a high aperture ratio can be provided.

### CITATION LIST

### Patent Literature

Patent Literature 1: JP 2003-21845 A
Patent Literature 2: JP 2007-34327 A
Patent Literature 3: JP 2001-33818 A
Patent Literature 4: JP 2010-91904 A

### SUMMARY OF INVENTION

### Technical Problem

Through using such an active matrix substrate having a transparent electrode below the pixel electrodes in the liquid crystal panel, the present inventors have found that it is difficult in such a panel to repair defects using a laser by conventional methods if the defects are detected in an inspection step performed after assembling the active matrix substrate and the counter substrate and injecting liquid crystal between the substrates or in an inspection step performed after dripping liquid crystal on the active matrix substrate or the counter substrate and assembling the substrates. Specific examples of the defect include one in which a pixel which should appear black becomes a bright spot on the screen due to leakage current between wirings or disconnection of a wiring (e.g., a data signal line). When the bright spot occurs, a repair is required to turn the pixel causing the bright spot into a black spot.

FIG. 22 is a schematic cross-sectional view illustrating laser repair of a conventional liquid crystal display panel performed after a pair of substrates are assembled together. The panel in FIG. 22 includes a glass substrate 131 as a base and a gate insulating film 132, a drain lead-out wiring 113, a second insulating film 133, an auxiliary capacitance electrode 115, a third insulating film 134, and a pixel electrode 116 stacked in the stated order on the glass substrate 131. The auxiliary capacitance electrode 115 and the pixel electrode 116 are transparent electrodes. To display a bright spot pixel as a black spot in such a panel, a repairing technique of laser melting of the drain lead-out wiring 113 and the auxiliary capacitance electrode 115 as shown in FIG. 22, or a technique of laser melting of the auxiliary capacitance electrode 115 and the pixel electrode 116 may be used. A potential supplied to the auxiliary capacitance electrode 115 is set such that the pixel appears black after laser melting. When the drain lead-out wiring 113 and the auxiliary capacitance electrode 115 are connected or when the auxiliary capacitance electrode 115 and the pixel electrode 116 are connected, only the pixel(s) around the defect are turned into black spots, and thereby the bright spot is eliminated.

It is found that, however, if either or both of the target electrodes for laser melting is/are transparent electrodes (s), the precision of laser repair is reduced. This is because the transparent electrodes are less likely to absorb laser light, preventing a good connection between the auxiliary capacitance electrode and pixel electrode.

The present invention is devised in view of the above situation and aims to provide a liquid crystal panel which facilitates laser repair of a defect while including a transparent electrode as an electrode facing pixel electrodes with an insulating film therebetween.

### Solution to Problem

The present inventors made various studies on the structure facilitating laser repair for turning a pixel into a black spot. The studies led the inventors to the idea of changing the target of the laser repair from the transparent electrode facing the pixel electrode with an insulating film therebetween to a light-shielding electrode other than the transparent electrode. The inventors focused on connecting a light-shielding electrode which is located in a layer separated from the layer of the pixel electrode by an insulating film therebetween and electrically connected to the pixel electrode to another light-shielding electrode, rather than a direct laser repair of the pixel electrode. In addition, when the transparent electrode facing the pixel electrode with an insulating film therebetween is disposed in a layer above the wirings (a layer closer to the liquid crystal layer than the wirings are), the transparent electrode shields the liquid crystal layer from an electric field if predetermined signals are supplied to the target electrode of laser repair. Thus, the transparent electrode prevents alignment disorder of the liquid crystal molecules and image sticking.

The present inventors thus found the solution to the above problem and arrived at the present invention.

Accordingly, one aspect of the present invention is a liquid crystal display panel including a first substrate having an insulating substrate, a thin film transistor, a scan signal line, a first light-shielding electrode, a first insulating film, a second light-shielding electrode, a second insulating film, a transparent electrode, a third insulating film, and a pixel electrode, a second substrate having an insulating substrate, and a liquid crystal layer sandwiched between the first substrate and the second substrate, the second light-shielding electrode being located between the thin film transistor and the pixel electrode and connected to the pixel electrode through a connecting portion formed through the second insulating film and the third insulating film, the first light-shielding electrode at least partly overlapping with the second light-shielding electrode with the first insulating film therebetween, and the transparent electrode being in a layer closer to the liquid crystal layer than both a layer including the scan signal line and a layer including the second light-shielding electrode are.

The liquid crystal display panel includes a first substrate, a liquid crystal layer, and a second substrate. The first substrate is an active matrix substrate including an insulating substrate as a base, a thin film transistor (TFT), a scan signal line, a first light-shielding electrode, a first insulating film, a second light-shielding electrode, a second insulating film, a transparent electrode, a third insulating film, and a pixel electrode. The second substrate is a counter substrate including an insulating substrate as a base and optionally an electrode, a color filter, or the like.

The first light-shielding electrode can be used for laser repair, and also can be used as an auxiliary capacitance wiring. The second light-shielding electrode is located between the thin film transistor and the pixel electrode and connected to the pixel electrode through a connecting portion formed through the second insulating film and the third insulating film. The second light-shielding electrode may be, for example, a drain lead-out wiring between the TFT and the pixel electrode. Such a structure enables to turn only target pixel(s) into black spot(s).

The transparent electrode is in a layer closer to a liquid crystal layer than both a layer including the scan signal line and a layer including the second light-shielding electrode are. The uses of the transparent electrode may vary depending on the display modes. The transparent electrode may be used as an auxiliary capacitance electrode to form an auxiliary capacitance in combination with the pixel electrode, as a common electrode to generate an electric field in combination with the pixel electrode to control the alignment of the liquid crystal molecules, or the like.

The first light-shielding electrode at least partly overlaps with the second light-shielding electrode with the first insulating film and the second insulating film therebetween. The overlapping region of the first light-shielding electrode and the second light-shielding electrode can correspond to a laser repair region. Since both of the electrodes are light-shielding electrodes, the precision (success probability) of laser repair is improved.

The transparent electrode is in a layer closer to the liquid crystal layer than both a layer including the scan signal line and a layer including the second light-shielding electrode are. Since the transparent electrode is in a layer closer to the liquid crystal layer than both a layer including the scan signal line and a layer including the second light-shielding electrode are, the transparent electrode shields the liquid crystal layer from an electric field generated due to potentials supplied to the wiring and electrodes, preventing alignment disorder of the liquid crystal molecules and image sticking. Though the transparent electrode is not required to completely cover the scan signal line and the second light-shielding electrode, the transparent electrode preferably substantially entirely covers the scan signal line or the second light-shielding electrode, and more preferably substantially entirely covers both the scan signal line and the second light-shielding electrode, with the first insulating film and the second insulating film therebetween.

As long as the liquid crystal display panel essentially includes the above components, the liquid crystal display panel is not particularly limited by other components. The following will describe preferable embodiments of the liquid crystal display panel in detail. Here, the preferable embodiments include a combination of two or more of the preferable embodiments of the liquid crystal display panel described below.

The transparent electrode is preferably a common electrode, the common electrode and the pixel electrode generating an electric field in the liquid crystal layer between these electrodes. A potential supplied to the first light-shielding electrode is preferably the same as that supplied to the transparent electrode. When the first light-shielding electrode with such a potential and the second light-shielding electrode are connected by laser melting, the difference between the potential of the pixel electrode on the first substrate and that of the transparent electrode (common electrode) on the first substrate becomes zero, enabling to turn the pixel into a black spot. This embodiment may be suitably used in liquid crystal alignment control modes in which a pixel electrode and a common electrode are formed on a first substrate, such as an IPS mode and FFS mode.

The liquid crystal display panel is preferably a normally black display panel. Preferably, the second substrate has a common electrode, and a potential supplied to the first light-shielding electrode is the same as that supplied to the common electrode. When the first light-shielding electrode with such a potential and the second light-shielding electrode are connected by laser melting, the difference between the potential of the pixel electrode on the first substrate and that of the common electrode on the second substrate becomes zero, enabling to turn the pixel to a black spot. This embodiment may be suitably used in liquid crystal alignment modes in which a pixel electrode is formed on the first substrate and the common electrode is formed on the second substrate, such as a VA mode, multi-domain vertical alignment (MVA) mode, and continuous pinwheel alignment (CPA) mode.

The liquid crystal display panel is preferably a normally white display panel. Preferably, the second substrate has a common electrode, and a potential supplied to the first light-shielding electrode is different from that supplied to the common electrode. When the first light-shielding electrode with such a potential and the second light-shielding electrode are connected by laser melting, a potential difference is created between the pixel electrode on the first substrate and the common electrode on the second substrate, enabling to turn the pixel into a black spot. This embodiment is suitably used in liquid crystal alignment modes in which a pixel electrode is formed on the first substrate and the common electrode is formed on the second substrate, such as a TN mode and super twisted nematic (STN) mode.

The first light-shielding electrode preferably extends substantially parallel to the scan signal line and is in the same layer as the scan signal line. In this case, the first light-shielding electrode and the scan signal line are formed in the same layer without crossing each other, improving production efficiency. The first light-shielding electrode may have a bent portion, a branch part, and the like as long as it is not connected to the scan signal line.

The liquid crystal display panel preferably further has a data signal line. Preferably, the first light-shielding electrode extends substantially parallel to the data signal line, and has a portion located in the same layer as the data signal line and a portion located in the same layer as the scan signal line. In this case, the first light-shielding electrode can be manufactured using materials of the scan signal line and the data signal line, improving production efficiency.

The first light-shielding electrode and the second light-shielding electrode preferably have an overlapping region including a region of at least 5 μm square. If at least such a region is secured as a laser repair region, the precision of laser repair is significantly improved.

### Advantageous Effects of Invention

The liquid crystal display panel of the present invention provides a structure facilitating laser repair of a defective pixel caused by leakage current between wires or electrodes even if the panel has a transparent electrode other than pixel electrodes in a layer other than the layer including the pixel electrodes.

### BRIEF DESCRIPTION OF DRAWINGS

FIG. 1 is a schematic cross-sectional view of a liquid crystal display panel of Embodiment 1 during laser irradiation.

FIG. 2 is a schematic cross-sectional view of the liquid crystal display panel of Embodiment 1 after laser irradiation.

FIG. 3 is a schematic plan view of an active matrix substrate of Embodiment 1.

FIG. 4 is a schematic plan view illustrating only a transparent Cs electrode of the active matrix substrate of Embodiment 1.

FIG. 5 is a schematic plan view of laser repair regions in the liquid crystal display panel of Embodiment 1.

FIG. 6 is a schematic plan view of an active matrix substrate of Embodiment 2.

FIG. 7 is a schematic plan view illustrating only a transparent Cs electrode of the active matrix substrate of Embodiment 2.

FIG. 8 is a schematic plan view of an active matrix substrate of Embodiment 3.

FIG. 9 is a schematic plan view of an active matrix substrate of Embodiment 4.

FIG. 10 is a schematic plan view illustrating only a transparent Cs electrode of the active matrix substrate of Embodiment 4.

FIG. 11 is a schematic plan view of an active matrix substrate of Embodiment 5.

FIG. 12 is a schematic plan view illustrating only a common electrode of the active matrix substrate of Embodiment 5.

FIG. 13 is a schematic cross-sectional view of a liquid crystal display panel of Embodiment 5 during laser irradiation.

FIG. 14 is a schematic cross-sectional view of the liquid crystal display panel of Embodiment 5 after laser irradiation.

FIG. 15 is a schematic plan view of an active matrix substrate of Embodiment 6.

FIG. 16 is a schematic plan view illustrating only a common electrode of the active matrix substrate of Embodiment 6.

FIG. 17 is a schematic plan view of an active matrix substrate of Embodiment 7.

FIG. 18 is a schematic plan view illustrating only a transparent Cs electrode of the active matrix substrate of Embodiment 7.

FIG. 19 is a schematic cross-sectional view of a liquid crystal display panel of Embodiment 7 during laser irradiation.

FIG. 20 is a schematic cross-sectional view of the liquid crystal display panel of Embodiment 7 after laser irradiation.

FIG. 21 is a schematic plan view of an active matrix substrate of Embodiment 8.

FIG. 22 is a schematic cross-sectional view of a conventional liquid crystal display panel during laser repair performed after the pair of substrates are assembled together.

### DESCRIPTION OF EMBODIMENT

In the following, the present invention is described more in detail based on, but not limited to embodiments with reference to drawings.

The “pixel” herein refers to a region surrounded by two adjacent scan signal lines (gate bus lines) and two adjacent data signal lines (source bus lines).

The “region” herein includes not only a surface but also the depth from the surface in the normal direction of the active matrix substrate surface.

The “electrode” herein includes so-called “wirings”.

Embodiments 1 to 8 describe a laser repair treatment for shorting the auxiliary capacitance wiring and the drain lead-out wiring.

The structures of the liquid crystal panels of Embodiments 1 to 8 are useful in a laser repair treatment of, for example, a TFT (thin film transistor) in which the source electrode and the drain electrode has shorted, a drain lead-out wiring a part of which is disconnected, or the like.

Specifically, the liquid crystal panels of Embodiments 1 to 8 may be used in liquid crystal display devices such as televisions, personal computers, cellular phones, car navigation equipment, and information displays.

### Embodiment 1

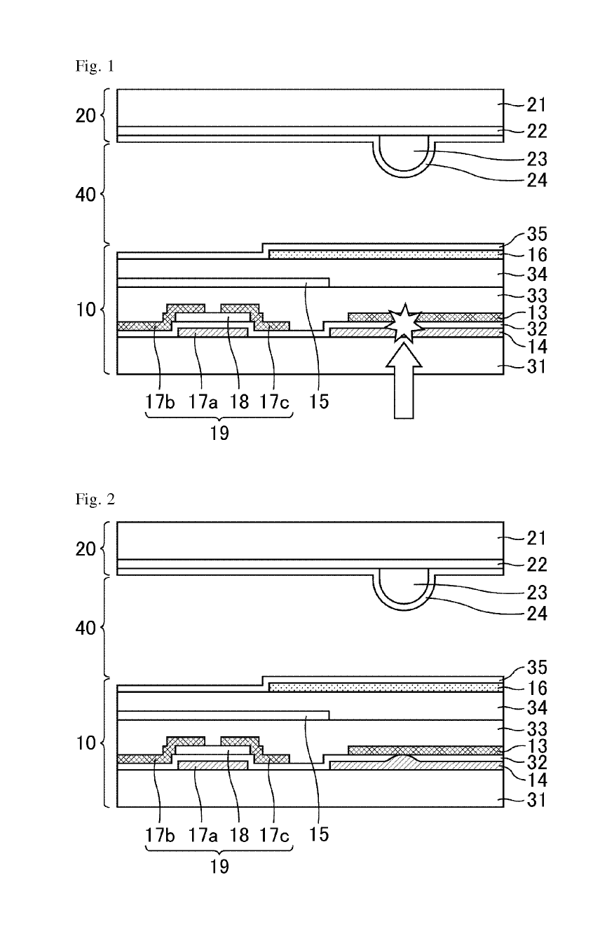

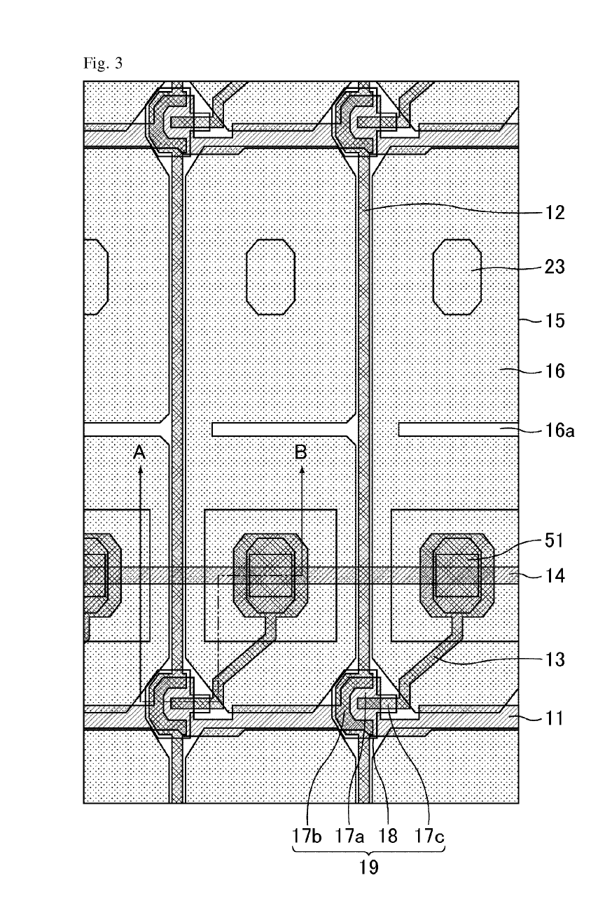

Embodiment 1 shows a CPA mode liquid crystal display panel. The liquid crystal display panel of Embodiment 1 is a normally black liquid crystal display panel. FIGS. 1 and 2 are schematic cross-sectional views of the liquid crystal display panel of Embodiment 1. FIG. 1 illustrates the state during laser irradiation, and FIG. 2 illustrates the state after the laser irradiation. FIG. 1 and FIG. 2 are also schematic cross-sectional views taken along the line A-B of FIG. 3 described below.

The liquid crystal display panel of Embodiment 1 includes an active matrix substrate (first substrate) 10, a counter substrate (second substrate) 20, and a liquid crystal layer 40 sandwiched between the active matrix substrate 10 and the counter substrate 20. The liquid crystal display panel of Embodiment 1 has a protrusion 23 in the shape of a pillar (in the shape of a dot in a plan view) on the counter substrate 20. Specifically, the protrusion 23 is made of an insulating material and formed on a liquid crystal layer-side surface of a common electrode 22. The protrusion 23 is hereinafter also referred to as a rivet. A hole, for example, may be formed on the common electrode 22 in place of the protrusion 23. When no voltage is applied, almost all of the liquid crystal molecules except those around the rivet 23 or hole are aligned in a direction perpendicular to the substrate surface. When a voltage is applied to the liquid crystal layer 40 in such a state, the liquid crystal molecules are radially aligned toward the rivet 23 or hole. This results in excellent viewing angle characteristics. Suitable insulating materials used in the rivet 23 include transparent resins such as phenolnovolac photosensitive resins.

The active matrix substrate 10 includes a transparent glass substrate (insulating substrate) 31, gate bus lines (scan signal lines) 11 and an auxiliary capacitance wiring (first light-shielding electrode) 14, a gate insulating film (first insulating film) 32, source bus lines (data signal lines) 12 and drain lead-out wirings (second light-shielding electrode) 13, a second insulating film 33, a transparent auxiliary capacitance (Cs) electrode (transparent electrode) 15, a third insulating film 34, pixel electrodes 16, and an alignment film 35 stacked in the stated order, the alignment film 35 being on the liquid crystal layer 40 side. The gate bus lines 11 and the auxiliary capacitance wirings 13 are in the same layer. The source bus lines 12 and the drain lead-out wirings 13 are in the same layer. Each TFT 19 has a semiconductor layer 18, a gate electrode 17a, a source electrode 17b, and a drain electrode 17c. The gate electrode 17a, the source electrode 17b, and the drain electrode 17c are connected to, respectively, the corresponding gate bus line 11, source bus line 12, and pixel electrode 16.

The counter substrate 20 includes a transparent glass substrate (insulating substrate) 21, a common electrode 22, rivets 23, and an alignment film 24 stacked in the stated order, the alignment film 24 being on the liquid crystal layer 40 side.

The auxiliary capacitance wiring 14 and the transparent Cs electrode 15 on the active matrix substrate 10 and the common electrode 22 on the counter substrate 20 are held at the same potential. The auxiliary capacitance wiring 14, the transparent Cs electrode 15, and the common electrode 22 may be directly connected through a peripheral circuit. Alternatively, the same potential may be applied through different pathways.

In laser repair in Embodiment 1, laser light from the glass substrate 31 side is directed to the auxiliary capacitance wiring 14 as shown with an arrow in FIG. 1. By the laser irradiation of the auxiliary capacitance wiring 14, the auxiliary capacitance wiring 14 is melted and brought into contact with the drain lead-out wiring 13 overlapping with the auxiliary capacitance wiring 14. Thereby, these wirings are connected. Since the light-shielding electrodes can be melt-connected to each other in Embodiment 1, laser repair is performed with a high precision. The drain lead-out wiring 13 and the auxiliary capacitance wiring 14 thus connected have the same potential. As a result, the potential of the pixel electrode 16 becomes equal to that of the common electrode 22 on the counter substrate 20, so that no voltage can be applied to the liquid crystal layer 40. Laser melting in the overlapping region of the drain lead-out wiring 13 and the auxiliary capacitance wiring 14 thus allows the defective picture element to be a black spot for longer time, thereby obscuring the defect. This improves the yield of the panel.

FIG. 3 is a schematic plan view of the active matrix substrate of Embodiment 1. The active matrix substrate of Embodiment 1 has the gate bus lines 11 and the source bus lines 12 formed such that these intersect each other and surround the pixel electrodes 16. The gate bus lines 11, the source bus lines 12, and the pixel electrodes 16 may partly overlap. The active matrix substrate also has the TFTs (thin film transistor) 19 near the contacting portions of the gate bus lines 11 and the source bus lines 12.

The gate electrode 17a of each TFT 19 is extended from the gate bus line 11. The source electrode 17b of the TFT 19 is not a linear portion but a bent portion of the source bus line 12. The source electrode 17b and the drain electrode 17c of the TFT 19 are formed directly on the semiconductor layer 18, not through a contacting portion penetrating the insulating film. This reduces the thickness of the insulating film located between the auxiliary capacitance wiring 14 and the drain lead-out wiring 13, facilitating laser repair. The drain lead-out wiring 13 is extended from the drain electrode 17c of the TFT 19. The drain lead-out wiring 13 partly bends and extends to near the center of the pixel. The drain lead-out wiring 13 has a large-area portion near the center of the pixel, and is connected to the corresponding pixel electrode 16 through a contacting portion 51 penetrating the second insulating film 33 and the third insulating film 34. The gate electrode 17a overlaps with the semiconductor layer 18 with the gate insulating film 32 therebetween. The source electrode 17b is connected to the drain electrode 17c through the semiconductor layer 18. Scan signals input to the gate electrode 17a through the gate bus line 11 control the amount of current through the semiconductor layer 18, and thereby controlling the transmission of data signals input through the source bus line 12 to the source electrode 17b, the semiconductor layer 18, the drain electrode 17c, the drain lead-out wiring 13, and the pixel electrode 16 in the stated order.

The pixel electrodes 16 are disposed in the respective regions surrounded by the source bus lines 12 and the gate bus lines 11. Each pixel electrode 16 is substantially rectangular. The pixel electrodes 16 are arranged in a matrix. Each pixel electrode 16 has a slit 16a crossing the center of the electrode and is separated into an upper section and a lower section with abridge therebetween. One rivet 23 is disposed near the center of each of the upper section and the lower section. That is, each pixel has two rivets 23 in Embodiment 1. Since the liquid crystal molecules are radially aligned around the rivets, division of each pixel electrode 16 enables to achieve a good balance between domains different from each other in the alignment of the liquid crystal.

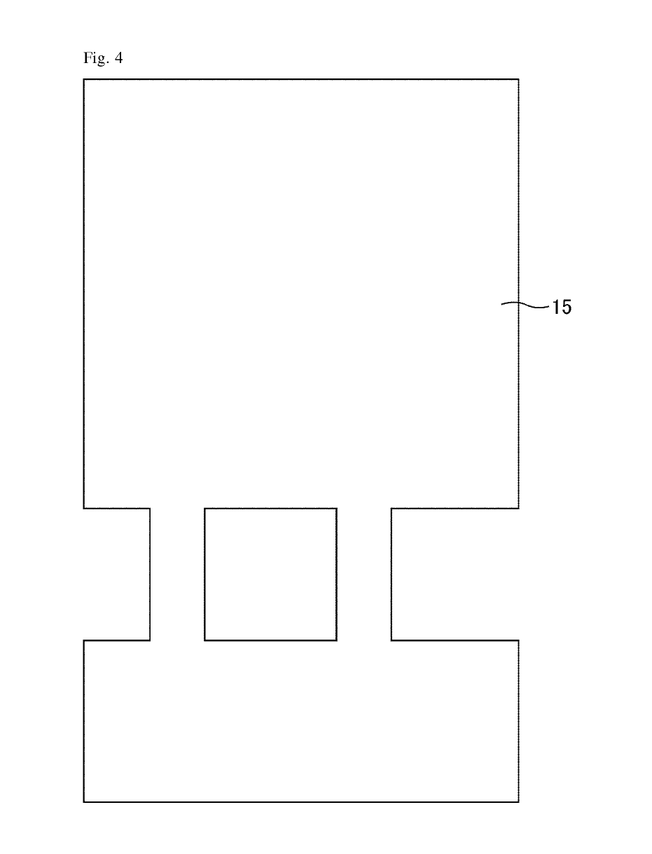

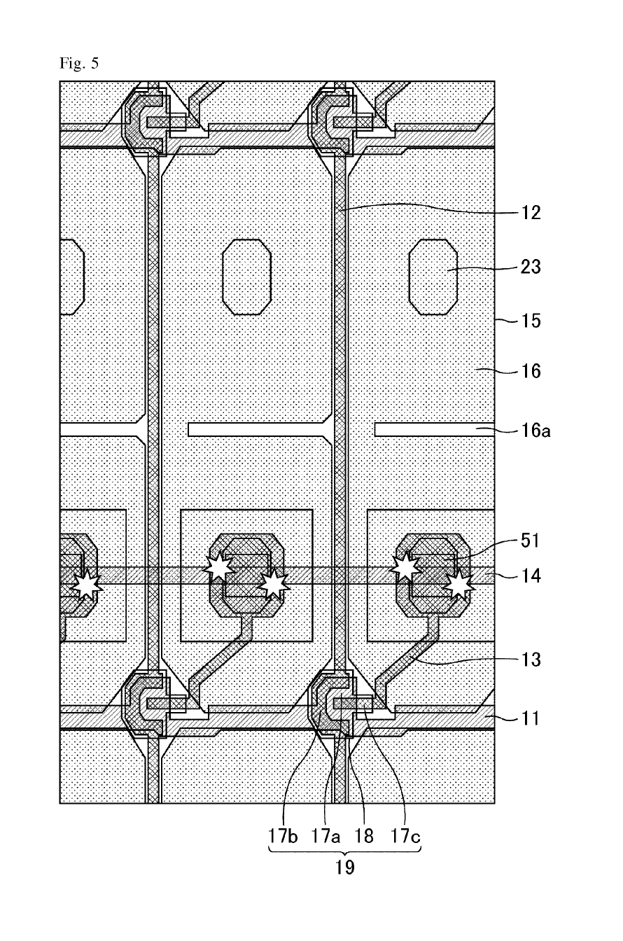

FIG. 4 is a schematic plan view illustrating only the transparent Cs electrode of the active matrix substrate of Embodiment 1. The material of the transparent Cs electrode 15 may be, for example, a transparent conductive material such as indium tin oxide (ITO), indium zinc oxide (IZO), zinc oxide (ZnO), and tin oxide (SnO), an alloy thereof, or the like. In Embodiment 1, the transparent Cs electrode 15 serves as a main auxiliary capacitor. This prevents reduction in aperture ratio due to the auxiliary capacitor, enabling to maintain a high transmissivity.

The transparent Cs electrode 15 substantially entirely covers the entire gate bus lines 11 and source bus lines 12 except that the electrode 15 has through-holes overlapping with the contacting portions of the drain lead-out wirings 13 and the pixel electrodes 16. The transparent Cs electrode 15 thus blocks an electric field generated by the bus lines, preventing reduction in contrast caused by image sticking and alignment disorder due to the electric field. This leads to production of a liquid crystal display panel having high display quality.

In Embodiment 1, the auxiliary capacitance wiring 14 is formed side by side parallel to the gate bus lines 11 as shown in FIG. 3. Each drain lead-out wiring 13 is extended from the drain electrode 17c of the TFT 19 toward the corresponding pixel electrode 16. The drain lead-out wiring 13 has a large-area portion at the end thereof. This allows the drain lead-out wiring 13 and the auxiliary capacitance wiring 14 with the gate insulating film 32 therebetween to generate a certain capacitance, more efficiently securing the auxiliary capacitance in pixels of a given size. As a result, the liquid crystal display is more stabilized.

FIG. 5 is a schematic plan view illustrating laser repair regions of the liquid crystal display panel of Embodiment 1. The laser repair regions are marked with star-shaped marks in FIG. 5. The number of laser repair regions in each pixel may be one, and more preferably two in terms of certainty. In Embodiment 1, each laser repair region is preferably 5 lam square or larger from the viewpoint of repairing efficiency. That is, the overlapping area of the auxiliary capacitance wiring 14 and the drain lead-out wiring 13 preferably includes a region of at least 5 μm square.

The following will describe the materials and the manufacturing method of the components.

The materials of the insulating substrates 21 and 31 are not particularly limited as long as they are transparent. Examples thereof include glass and plastics. Suitable materials of the gate insulating film (first insulating film) 32, the second insulating film 33, and the third insulating film 34 include transparent materials such as silicon nitride, silicon oxide, and photosensitive acrylic resins. These insulating films are produced by, for example, forming a silicon nitride film by the plasma enhanced chemical vapor deposition (PECVD) method and forming a photosensitive acrylic resin film of the silicon nitride film by the die-coating (application) method.

The gate bus lines 11, the source bus lines 12, the auxiliary capacitance wiring 14, the drain lead-out wirings 13, and the electrodes 17a, 17b, and 17c of each TFT 19 may be produced by forming a single or plurality of films of metals (e.g., titanium, aluminum, molybdenum, copper, chromium, alloys thereof) by the sputtering method or the like and patterning the film by photolithography or the like. The wirings and electrodes in the same layer may be produced from the same material for more efficient production.

The semiconductor layer 18 of each TFT 19 may include, for example, a high-resistance semiconductor layer made of amorphous silicon, polysilicon, or the like; and a low-resistance semiconductor layer made of n⁺ amorphous silicon, which is amorphous silicon doped with impurities such as phosphorous. The material of the semiconductor layer 18 may be an oxide semiconductor such as zinc oxide. The shape of the semiconductor layer 18 may be determined through patterning by photolithography after the layer is formed by the PECVD method or the like.

The pixel electrodes 16 and the common electrode 22 may be produced by forming a single or plurality of films of transparent conductive materials such as indium tin oxide (ITO), indium zinc oxide (IZO), zinc oxide (ZnO), and tin oxide (SnO), or alloys thereof by the sputtering method or the like and then patterning the film by photolithography or the like, as in the case of the transparent Cs electrode 15. The slit of each pixel electrode 16 and the through-holes of the transparent Cs electrode 15 may be formed at the same time as the patterning.

Suitable materials of the color filter are photosensitive resins (color resists) which transmit lights corresponding to the respective colors. The material of the black matrix is not particularly limited as long as it has light-shielding properties. Suitable examples thereof include resin materials containing a black pigment; and metal materials having light-shielding properties.

After a plurality of pillar-shaped spacers are formed on either one of the active matrix substrate 10 and the counter substrate 20 prepared, the substrates are assembled together using a sealant. The liquid crystal layer 40 is formed between the active matrix substrate 10 and the counter substrate 20. If the liquid crystal layer is formed by the one drop filling method, the liquid crystal material is dropped onto the substrates before the assembling of the substrates. If the vacuum injection method is used, the liquid crystal material is injected between the substrates after the assembling. Subsequently, a polarizer, a retarder, and the like are applied to the surface opposite to the liquid crystal layer 40 of each of the substrates. Thereby, a liquid crystal display panel is produced. The liquid crystal display panel is further mounted with a gate driver, a source driver, a display control circuit, and the like and combined with a backlight and the like to provide a liquid crystal display device suitable for the intended uses.

The structure of the liquid crystal display panel of Embodiment 1 may be observed and analyzed by, for example, observation using an optical microscope (Semiconductor/FPD Inspection Microscopes MX61L, produced by Olympus Corporation), cross-section analysis and elemental analysis using a scanning transmission electron microscope energy dispersive X-ray spectroscope (STEM-EDX) (HD-2700, produced by Hitachi, Ltd.), or the like.

Suitable examples of the laser used for the repair in the liquid crystal display panel of Embodiment 1 include a neodymium yttrium aluminum garnet laser (Nd:YAG Laser: HSL4000II, produced by Hoya Candeo Optronics Corporation).

### Embodiment 2

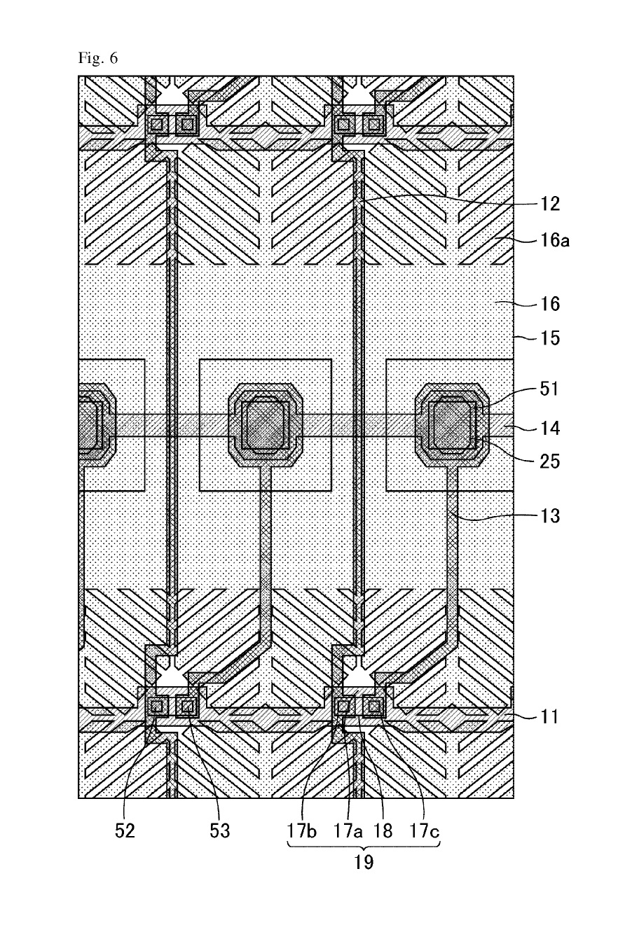

Embodiment 2 shows a modified CPA mode liquid crystal display panel. The liquid crystal display panel of Embodiment 2 is a normally black liquid crystal display panel. The liquid crystal display panel of Embodiment 2 is the same as that of Embodiment 1 except that the rivets or holes are not necessarily present, that the TFTs are different from those of Embodiment 1 in the structure, and that a plurality of diagonal slits are formed on the four corners of each pixel electrode. FIG. 6 is a schematic plan view of the active matrix substrate of Embodiment 2.

In Embodiment 2, the source electrode 17b of each TFT 19 is extended from the source bus line 12 and connected to the semiconductor layer 18 through a contacting portion 52 penetrating an interlayer insulating film formed on the semiconductor layer 18. The drain electrode 17c of the TFT 19 is connected to the semiconductor layer 18 through a contacting portion 53 penetrating the interlayer insulating film formed on the semiconductor layer 18. The drain lead-out wiring 13 is extended from the drain electrode 17c of the TFT 19. As in Embodiment 1, the drain lead-out wiring 13 partly bends and extends to near the center of the pixel. The drain lead-out wiring 13 has a large-area portion near the center of the pixel, and is connected to the corresponding pixel electrode 16 through the contacting portion 51 penetrating the second insulating film 33 and the third insulating film 34. The contacting portions 51, 52, and 53 may be formed by forming holes on each insulation film by dry etching or wet etching.

In Embodiment 2, a plurality of slits having different longitudinal directions are formed on the four corners of each pixel electrode 16. Each of the plurality of slits 16a extends in a direction diagonal to the outer edge of the pixel electrode 16. Specifically, when the pixel electrode 16 is divided by a longitudinal and a lateral bisectors in a plan view of the active matrix substrate, the plurality of slits 16a are formed in the upper half of the upper left region, the upper half of the upper right region, the lower half of the lower left region, and the lower half of the lower right region. The longitudinal directions of the slits in each of the regions are substantially 45° to the outer edge of the pixel electrode 16. The slit pattern is symmetric about the longitudinal bisector of the electrode 16 and about the lateral bisector of the pixel electrode 16. The slit pattern of the pixel electrode 16 may be formed at the time of patterning by photolithography.

In FIG. 6, each pixel has one rivet (or hole) 25 near the center of the pixel. That is, the rivet 25 is formed such that it overlaps with the contacting potion 51 of the drain lead-out wiring 13 and the pixel electrode 16. Since the slits 16a are formed, the liquid crystals molecules in Embodiment 2 are substantially radially aligned toward the center of the pixel without the rivet (or hole) 25 in the pixel. If the rivet (or hole) 25 is formed as shown in FIG. 6, the liquid crystal molecules are aligned radially in a balanced manner when voltage is applied to the liquid crystal layer.

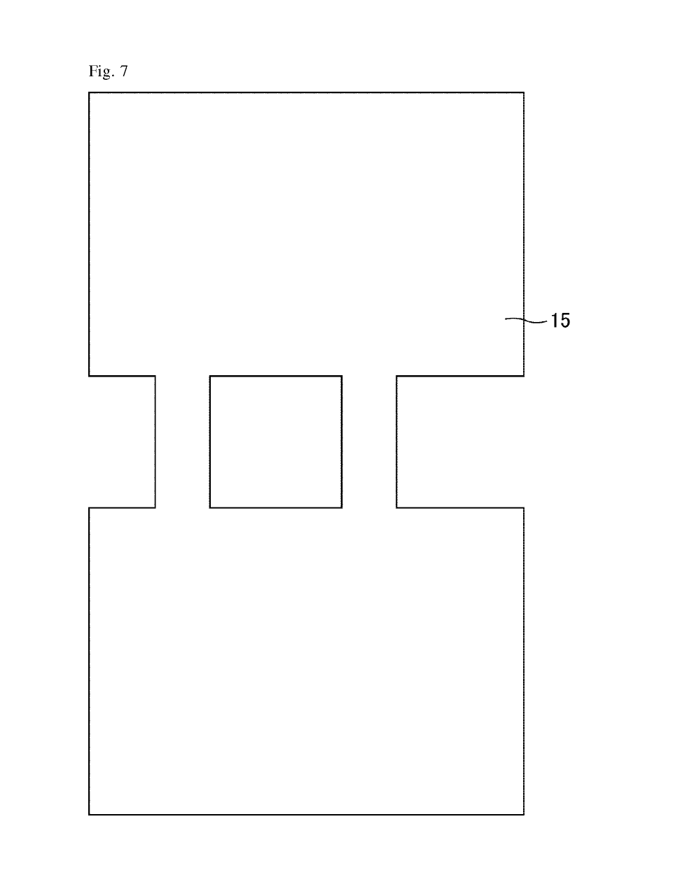

The transparent Cs electrode 15 has through-holes in regions overlapping with the contacting portions 51 where the drain lead-out wirings 13 and the pixel electrodes 16 are connected. The auxiliary capacitance wiring 14 and the transparent Cs electrode 15 on the active matrix substrate and the common electrode 22 on the counter substrate are held at the same potential. The auxiliary capacitance wiring 14, the transparent Cs electrode 15, and the common electrode 22 may be directly connected through a peripheral circuit or the like. Alternatively, the same potential may be applied through different pathways. FIG. 7 is schematic plan view illustrating only the transparent Cs electrode of the active matrix of Embodiment 2.

In Embodiment 2, the auxiliary capacitance wiring 14 is formed side by side parallel to the gate bus lines 11 and crosses the large-area portions of the drain lead-out wirings 13 as shown in FIG. 6. The auxiliary capacitance wiring 14 has large-area portions that fit the shape of the large-area portions of the drain lead-out wirings 13. Due to this structure, in Embodiment 2, laser irradiation of the auxiliary capacitance wiring 14 overlapping with the drain lead-out wirings 13 allows connection of the auxiliary capacitance wiring 14 and the drain lead-out wirings 13, and thus these wirings have the same potential. As a result, the repaired pixel appears black, eliminating the bright spot.

### Embodiment 3

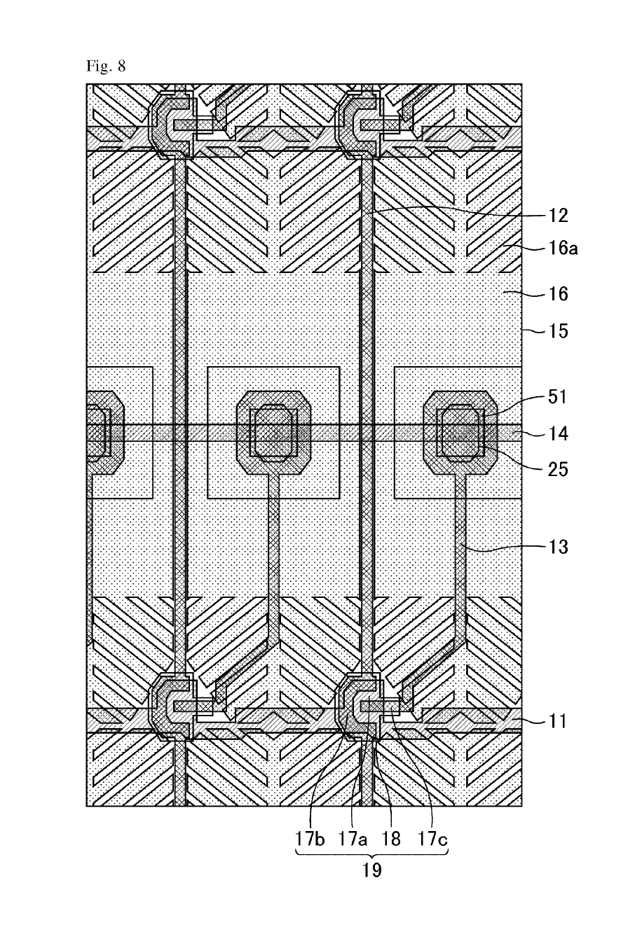

Embodiment 3 shows a modified CPA mode liquid crystal display panel. The liquid crystal display panel of Embodiment 3 is a normally black display panel. The liquid crystal display panel of Embodiment 3 is the same as the liquid crystal display panel of Embodiment 2 except for the difference in the structure of the TFTs. FIG. 8 is a schematic plan view of the active matrix substrate of Embodiment 3.

The structure of the TFTs 19 of Embodiment 3 is the same as that of the TFTs of Embodiment 1. The gate electrode 17a of each TFT 19 is extended from the gate bus line 11. The source electrode 17b of the TFT 19 is not a linear portion but a bent portion of the source bus line 12. The source electrode 17b and drain electrode 17c of the TFT 19 are formed directly on the semiconductor layer 18 not through contacting portions penetrating the insulating film. This allows the insulating film between the auxiliary capacitance wiring 14 and the drain lead-out wirings 13 to have a smaller thickness. Laser repair is therefore easier with TFTs having this structure than with TFTs having the structure described in Embodiment 2.

The liquid display panel of Embodiment 3 provides the same liquid crystal alignment properties and effect of blocking the electric field from the bus lines as the liquid crystal display panel of Embodiment 2.

### Embodiment 4

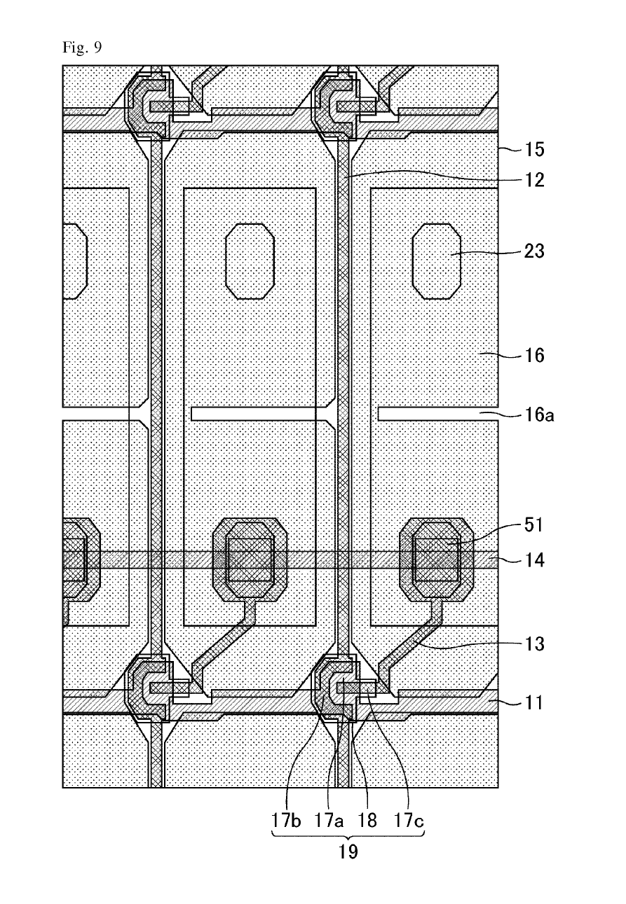

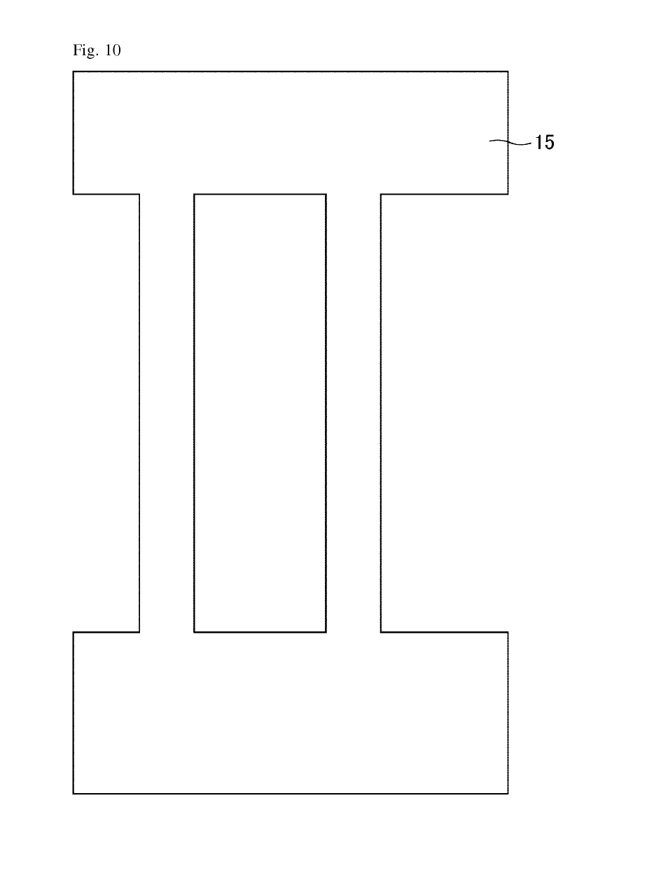

Embodiment 4 shows a CPA mode liquid crystal display panel. The liquid crystal display panel of Embodiment 4 is a normally black liquid crystal display panel. The liquid crystal display panel of Embodiment 4 is the same as that of Embodiment 1 except for the difference in the size of the through-holes formed in the transparent Cs electrode. FIG. 9 is a schematic plan view of the active matrix substrate of Embodiment 4. FIG. 10 is a schematic plan view illustrating only the transparent Cs electrode of the active matrix substrate of Embodiment 4.

Each through-hole formed in the transparent Cs electrode 15 of Embodiment 4 has a larger area than a through hole formed in the transparent Cs electrode 15 of Embodiment 1. The through-holes are substantially rectangular and fit the shape of the outer edge of the pixel electrodes 16. The size of the through-holes formed in the transparent Cs electrode 15 is appropriately determined depending on the auxiliary capacitance required. The present embodiment is suitably used when the auxiliary capacitance stored is too large to charge the pixel electrode 16, for example.

In Embodiment 4, the through-holes of the transparent Cs electrode 15 are formed not in regions overlapping with the gate bus lines 11 and the source bus lines 12 but in regions overlapping with the pixel electrodes 16. Thereby, the effect of blocking the electric field caused by the gate bus lines 11 and the source bus lines 12 is achieved, as in Embodiment 1.

The liquid display panel of Embodiment 4 provides the same liquid crystal alignment properties, effect of blocking the electric field caused by the bus lines, and precision of the laser repair as in Embodiment 1.

### Embodiment 5

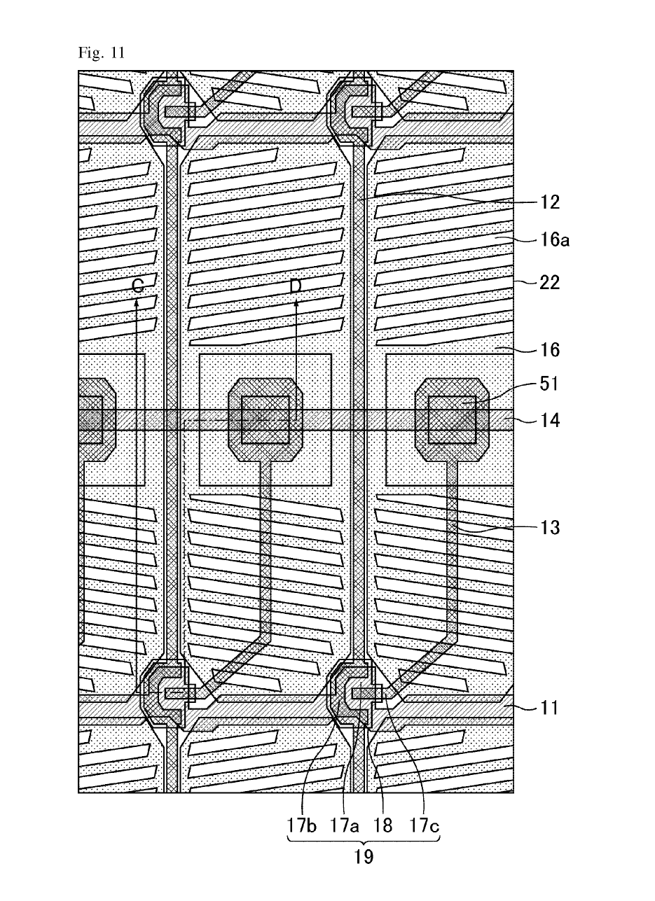

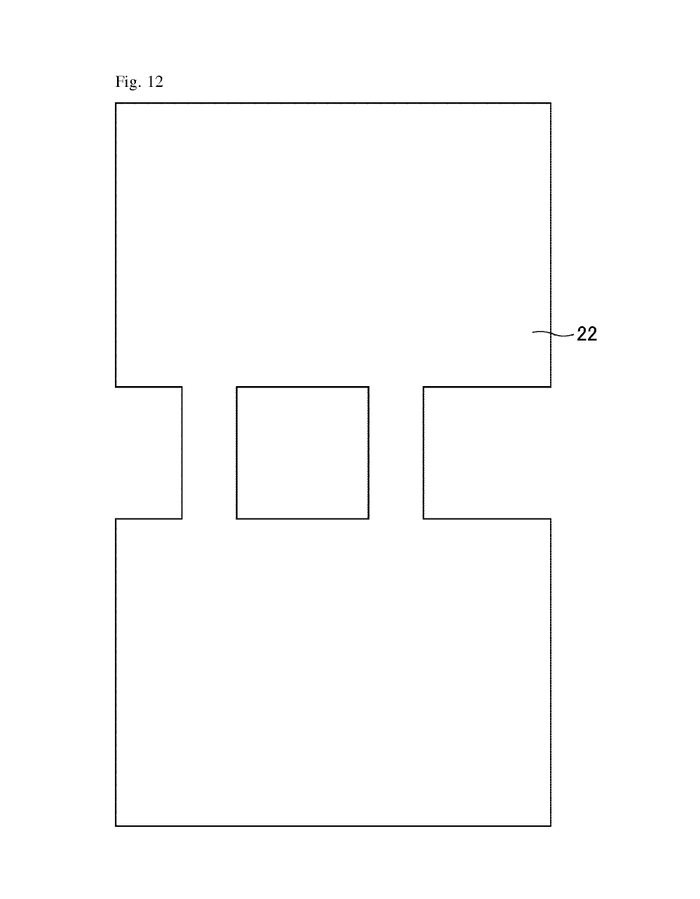

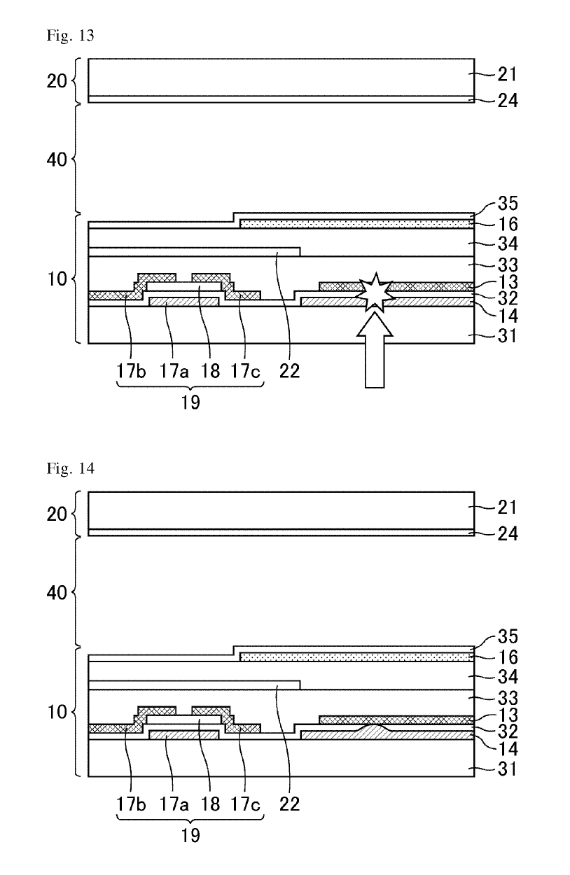

Embodiment 5 shows a FFS mode liquid crystal display panel. The liquid crystal display panel of Embodiment 5 is a normally black liquid crystal display panel. FIG. 11 is a schematic plan view of the active matrix substrate of Embodiment 5. FIG. 12 is a schematic plan view illustrating only the common electrode of the active matrix substrate of Embodiment 5. FIGS. 13 and 14 are schematic cross-sectional views of the liquid crystal display panel of Embodiment 5. FIG. 13 illustrates the state during laser irradiation, and FIG. 14 illustrates the state after the laser irradiation. FIGS. 13 and 14 are also schematic cross-sectional views taken along the line C-D in FIG. 11.

The active matrix substrate 10 of Embodiment 5 includes the TFTs 19, the gate bus lines 11, the source bus lines 12, the auxiliary capacitance wiring 14, the common electrode (transparent electrode) 22, the pixel electrodes 16, the insulating films electrically separating the wirings and electrodes, and an alignment film. The gate bus lines 11, the source bus lines 12, the auxiliary capacitance wiring 14, and the structure of the TFTs 19 in Embodiment 5 are the same as those of Embodiment 1, as shown in FIG. 11. The material of the common electrode 22 may be, for example, a transparent conductive material such as indium tin oxide (ITO), indium zinc oxide (IZO), zinc oxide (ZnO), and tin oxide (SnO), an alloy thereof, or the like.

Each pixel electrode 16 is a comb-shaped electrode having a substantially rectangular outer edge. The regions surrounded by the gate bus lines 11 and the source bus lines 12 have the respective pixel electrodes 16. The pixel electrodes 16 are arranged in a matrix form. Each pixel electrode 16 has a plurality of slits 16a. The slits 16a of each pixel electrode 16 lead to formation of an arc-like electric field in the liquid crystal layer between the pixel electrode 16 and the common electrode 22. Each slit 16a extends in a direction a few degrees from the direction parallel to the longitudinal direction of the gate bus lines 11. The slits 16a are not formed around the regions in which the contacting portions 51 of the drain lead-out wirings 13 and the pixel electrode 16 are located. Each drain lead-out wiring 13 partly bends and extends to near the center of the pixel. The drain lead-out wiring 13 has a large-area portion near the center of the pixel, and is connected to the pixel electrode 16 through the contacting portion 51 penetrating the second insulating film 33 and the third insulating film 34. The pattern of the slits 16a of each pixel electrode 16 is symmetric about the bisector of the longitudinal side of the pixel electrode 16. This symmetric structure leads to a balanced alignment of the liquid crystal.

In Embodiment 5, the common electrode is not on the counter substrate 20, but formed in a layer below the pixel electrodes 16 with the third insulating film 34 therebetween. A common potential supplied to the auxiliary capacitance wiring is also supplied to the common electrode 22. The common electrode 22 is on the entire surface independent of the borders of the pixels. In Embodiment 1, the common electrode 22 substantially entirely covers the gate bus lines 11 and source bus lines 12 with the first insulating film 32 and the second insulating film 33 therebetween. A through-hole is formed in a region overlapping with any of the contacting portions 51, where the drain lead-out wirings 13 and the pixel electrodes 16 are connected.

The liquid crystal display panel of Embodiment 5 includes the active matrix substrate (first substrate) 10, the counter substrate (second substrate) 20, and the liquid crystal layer 40 sandwiched between the active matrix substrate 10 and the counter substrate 20. The active matrix substrate 10 and the counter substrate 20 each have a surface having been subjected to a horizontal alignment treatment so that the liquid crystal molecules can be aligned substantially horizontally to the substrate surface when no voltage is applied. When voltage is applied, the liquid crystal molecules are aligned along the arc-like transverse electric field, causing change in birefringence of light passing through the liquid crystal layer 40. This FFS mode structure provides excellent viewing angle characteristics.

The active matrix substrate 10 includes the glass substrate 31, the gate bus lines 11 and the auxiliary capacitance wiring 14, the gate insulating film (first insulating film) 32, the drain lead-out wirings 13, the second insulating film 33, the common electrode (transparent electrode) 22, the third insulating film 34, the pixel electrodes 16, and the alignment film 35 stacked in the stated order, the alignment film 35 being on the liquid crystal layer 40 side. The gate bus lines 11 and the auxiliary capacitance wiring 14 are formed in the same layer. The source bus lines 12 and the drain lead-out wirings 13 are formed in the same layer. Each TFT 19 has the semiconductor layer 18, the gate electrode 17a, the source electrode 17b, and the drain electrode 17c. The gate electrode 17a, the source electrode 17b, and the drain electrode 17c are connected to, respectively, the corresponding gate bus line 11, source bus line 12, and pixel electrode 16.

The counter substrate 20 includes the glass substrate 21 and the alignment film 24 stacked in the stated order, the alignment film being on the liquid crystal layer 40 side.

The auxiliary capacitance wiring 14 and the common electrode 22 of the active matrix substrate 10 are held at the same potential. The auxiliary capacitance wiring 14 may be directly connected to the common electrode 22 through a peripheral circuit or the like. Alternatively, the same potential may be applied through different pathways.

In laser repair in Embodiment 5, laser light from the glass substrate 31 side is directed to the auxiliary capacitance wiring 14 as shown with an arrow in FIG. 13. By the laser irradiation of the auxiliary capacitance wiring 14, the auxiliary capacitance wiring 14 is melted and brought into contact with the drain lead-out wiring 13 overlapping with the auxiliary capacitance wiring 14. Thereby, these wirings are connected. Since in Embodiment 5 the light-shielding electrodes can be melt-connected to each other, laser repair is performed with a high precision. This connection allows the drain lead-out wiring 13 and the auxiliary capacitance wiring 14 to have the same potential. As a result, the potential of the pixel electrode 16 becomes equal to that of the common electrode 22 facing the pixel electrode 16 with the third insulating layer therebetween, so that no voltage can be applied to the liquid crystal layer 40. Laser melting in the overlapping region of the drain lead-out wiring 13 and the auxiliary capacitance wiring 14 thus allows a defective picture element to be a black spot for longer time, obscuring the defect. This improves the yield of the panel.

### Embodiment 6

Embodiment 6 shows a FFS mode liquid crystal display panel. The liquid crystal display panel of Embodiment 6 is a normally black liquid crystal display panel. The liquid crystal display panel of Embodiment 6 is the same as that of Embodiment 5 except the difference in the shape and the position of the slits formed on the pixel electrodes and the difference in the position of the large-area portions of the drain lead-out wirings extending from the drain electrodes of the TFTs.

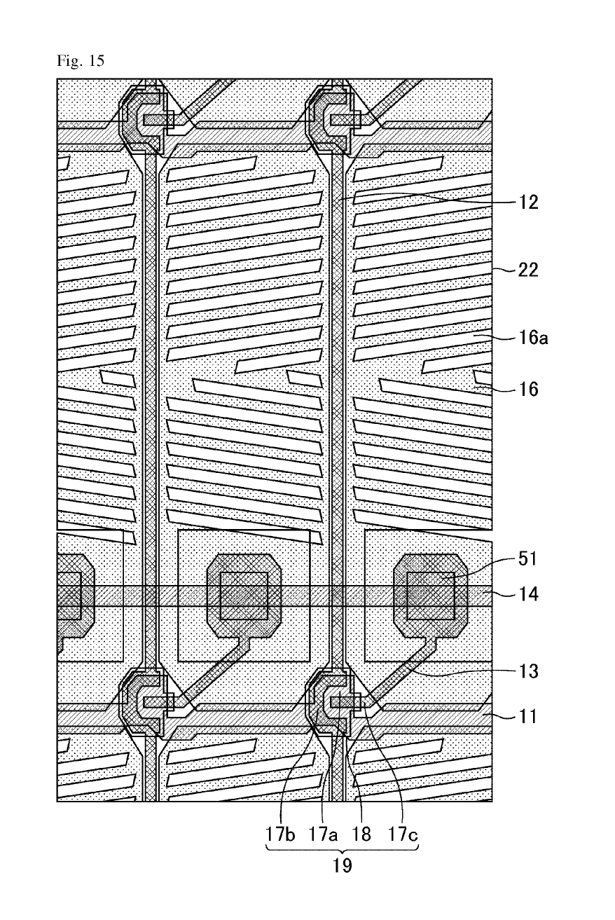

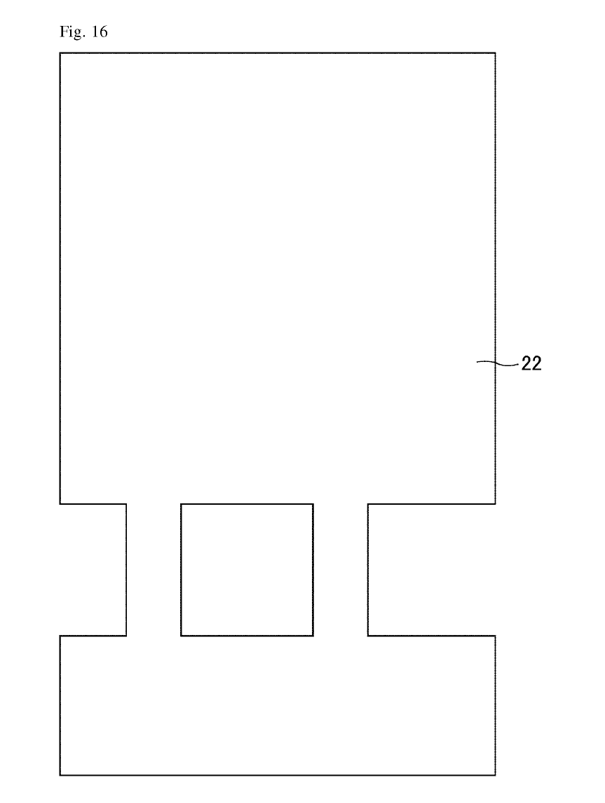

FIG. 15 is a schematic plan view of the active matrix substrate of Embodiment 6. FIG. 16 is a schematic plan view illustrating only the common electrode of the active matrix substrate of Embodiment 6.

In Embodiment 6, the large-area portion of each drain lead-out wiring 13 is formed not in the center of a pixel, but near the corresponding TFT 19.

Each pixel electrode 16 in Embodiment 6 is a comb-shaped electrode having a substantially rectangular outer edge, and the regions surrounded by the gate bus lines 11 and the source bus lines 12 have the respective pixel electrodes 16, as in Embodiment 5. Each slit 16a of the pixel electrode 16 extends in a direction a few degrees from the direction parallel to the longitudinal direction of the gate bus lines 11. Here, the slits 16a of each pixel electrode 16 are formed such that they do not overlap with the contacting portion 51 of the drain lead-out wiring 13 and the pixel electrode 16. Thus, the pattern of the slits is not symmetric about the bisector of the longitudinal side of the pixel electrode 16. Specifically, the pattern of the slits 16a of each pixel electrode 16 is substantially symmetric about a line parallel to the gate bus lines which is in the upper half of the pixel. This structure further stabilizes the alignment of the liquid crystal.

The liquid crystal display panel of Embodiment 6 provides the same precision of laser repair and effect of blocking the electric field caused by the bus lines as in Embodiment 5.

### Embodiment 7

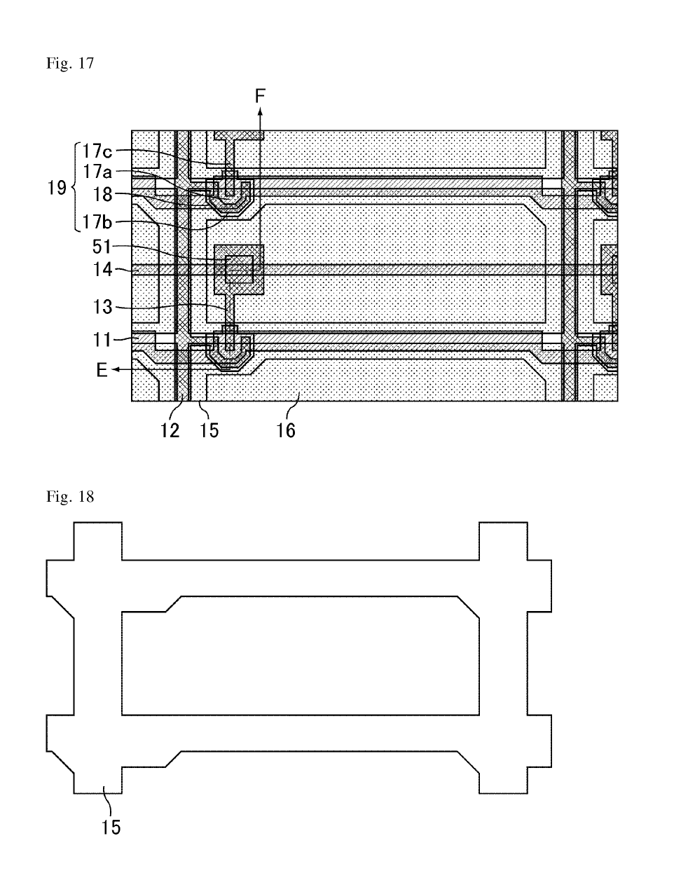

Embodiment 7 shows a TN mode liquid crystal display panel. The liquid crystal display panel of Embodiment 7 is a normally white liquid crystal display panel. FIG. 17 is a schematic plan view of the active matrix substrate of Embodiment 7. The active matrix substrate of Embodiment 7 includes the TFTs 19, the gate bus lines 11, the source bus lines 12, the transparent Cs electrode 15, the pixel electrodes 16, insulating films electrically separating the wirings and electrodes, and an alignment film. The material of the transparent Cs electrode 15 may be, for example, a transparent conductive material such as indium tin oxide (ITO), indium zinc oxide (IZO), zinc oxide (ZnO), and tin oxide (SnO), an alloy thereof, or the like. The transparent Cs electrode 15 is used as an auxiliary capacitance part, which prevents reduction in aperture ratio due to the auxiliary capacitance part and allows a high aperture ratio to be maintained. The counter substrate includes color filters, black matrix, a common electrode, and an alignment film. The color filters and black matrix may be formed on the active matrix substrate instead of on the counter substrate.

The pixel electrodes 17 are disposed on the respective regions surrounded by the source bus lines 12 and the gate bus lines 11. Each pixel electrode 16 is substantially rectangular. The pixel electrodes 16 are arranged in a matrix form. The pixel electrodes 16 in Embodiment 7 have no slit.

The gate electrode 17a of each TFT 19 in Embodiment 7 is extended from the gate bus line 11. The source bus line 12 is partly branched, and the branch part is connected to the source electrode 17b of the TFT 19. The drain lead-out wiring 13 is extended from the drain electrode 17c of the TFT 19 along the drawing direction of the source bus lines 12. The drain lead-out wiring 13 does not extend to near the center of the pixel, and has a large-area portion near the TFT 19. The drain lead-out wiring 13 is connected to the corresponding pixel electrode 16 through a contacting portion penetrating the second insulating film 33 and the third insulating film 34.

FIG. 18 is a schematic plan view illustrating only the transparent Cs electrode of the active matrix substrate of Embodiment 7. In Embodiment 7, the through-holes of transparent Cs electrode 15 are substantially rectangular and fit the shape of the outer edge of the pixel electrodes 16. That is, the transparent Cs electrode 15 is formed such that the electrode 15 does not overlap with the contacting portions 51 of the drain lead-out wirings 13 and the pixel electrodes 16 but overlaps with the gate bus lines 11 and the source bus lines 12. This provides the effect of blocking the electric field caused by the gate bus lines 11 and the source bus lines 12.

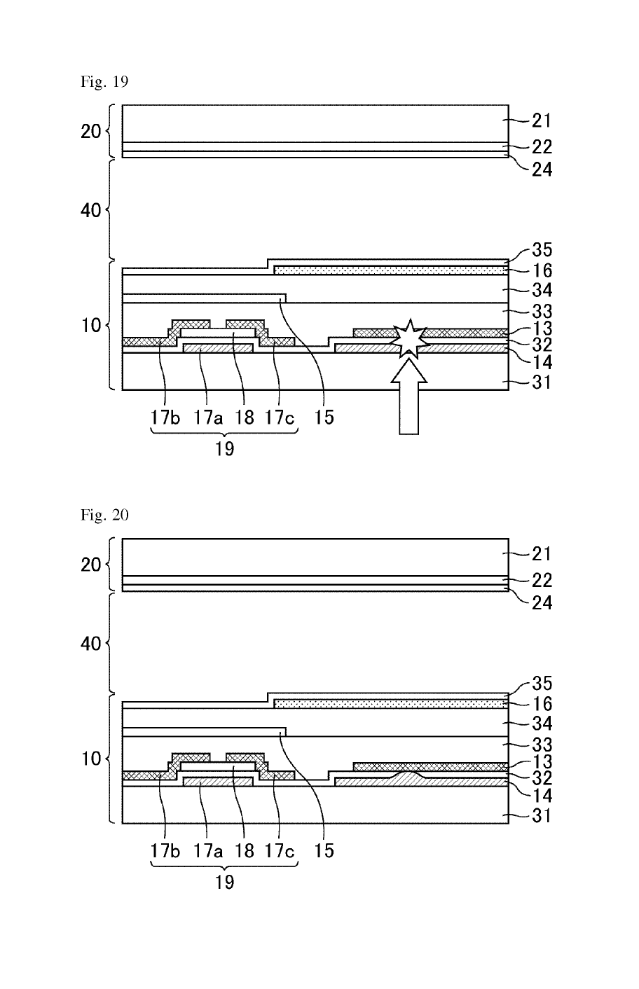

FIGS. 19 and 20 are schematic cross-sectional views of the liquid crystal display panel of Embodiment 7. FIG. 19 illustrates the state during laser irradiation and FIG. 20 illustrates the state after the laser irradiation. FIGS. 19 and 20 are also schematic cross-sectional views taken along the line E-F in FIG. 17. The liquid crystal display panel of Embodiment 7 includes the active matrix substrate (first substrate) 10, the counter substrate (second substrate) 20, and the liquid crystal layer 40 sandwiched between the active matrix substrate 10 and the counter substrate 20. The active matrix substrate 10 and the counter substrate 20 each have an alignment-treated surface. The alignment treatment directions of the substrates are perpendicular to each other. When no voltage is applied, the liquid crystal molecules near the substrate surfaces are aligned horizontally to the substrate surfaces, and the alignment direction of the liquid crystal molecules is continuously rotated from one substrate to the other, forming a 90 degree twist of the molecules in the in-plane direction of the substrate. When voltage is applied, the liquid crystal molecules are uniformly tilted in the same direction, resulting in change in the birefringence of light passing through the liquid crystal layer 40.

The active matrix substrate 10 includes the glass substrate 31, the gate bus lines 11 and the auxiliary capacitance wiring 14, the gate insulating film (first insulating film) 32, the drain lead-out wirings 13, the second insulating film 33, the transparent auxiliary capacitance (Cs) electrode (transparent electrode) 14, the third insulating film 34, the pixel electrodes 16, and the alignment film 35 stacked in the stated order, the alignment film being on the liquid crystal layer 40 side. The gate bus lines 11 and the auxiliary capacitance wiring 14 are formed in the same layer. The source bus lines 12 and the drain lead-out wirings 13 are formed in the same layer. Each TFT 19 includes the semiconductor layer 18, the gate electrode 17a, the source electrode 17b, and the drain electrode 17c. The gate electrode 17a, the source electrode 17b, and the drain electrode 17c are connected to, respectively, the corresponding gate bus line 11, source bus line 12, and pixel electrode 16.

The counter substrate 20 includes the glass substrate 21, the common electrode 22, and the alignment film 24 stacked in the stated order, the alignment film being on the liquid crystal layer 40 side.

Signals supplied to the auxiliary capacitance wiring 14 and the transparent Cs electrode 15 of the active matrix substrate 10 and the common electrode 22 of the counter substrate 20 are set so that a potential difference sufficient to provide a black display can be generated. For example, when the potential of the common electrode 22 is set to be 0 V in a liquid crystal display panel which requires a potential difference of 5 V in the liquid crystal layer to provide a black display, the potential supplied to the auxiliary capacitance wiring 14 and the pixel electrodes 16 is set to be +5 V or −5 V.

In laser repair in Embodiment 7, the defective portion with leakage current or the like is firstly removed by a laser. Subsequently, laser light from the glass substrate 31 side is directed to the auxiliary capacitance wiring 14 as shown with an arrow in FIG. 19. By the laser irradiation of the auxiliary capacitance wiring 14, the auxiliary capacitance wiring 14 is melted and brought into contact with the drain lead-out wiring 13 overlapping with the auxiliary capacitance wiring 14. Thereby, these wirings are connected. Since in Embodiment 7 the light-shielding electrodes can be melt-connected to each other, the laser repair is performed with a high precision. By this laser repair, the drain lead-out wiring 13, the auxiliary capacitance wiring 14, and the pixel electrode 16 all have the same potential, while having a different potential from the common electrode 22 on the counter substrate 20. Thus, the voltage application to the liquid crystal layer 40 is maintained. Laser melting in the overlapping region of the drain lead-out wiring 13 and the auxiliary capacitance wiring 14 thus allows the defective picture element to be a black spot for longer time, obscuring the defect. This improves the yield of the panel.

### Embodiment 8

Embodiment 8 shows a TN mode liquid crystal display panel. The liquid crystal display panel of Embodiment 8 is a normally white liquid crystal display panel. The liquid crystal display panel of Embodiment 8 is the same as that of Embodiment 7 except for the difference in the structure of the auxiliary capacitance wiring and the drain lead-out wiring.

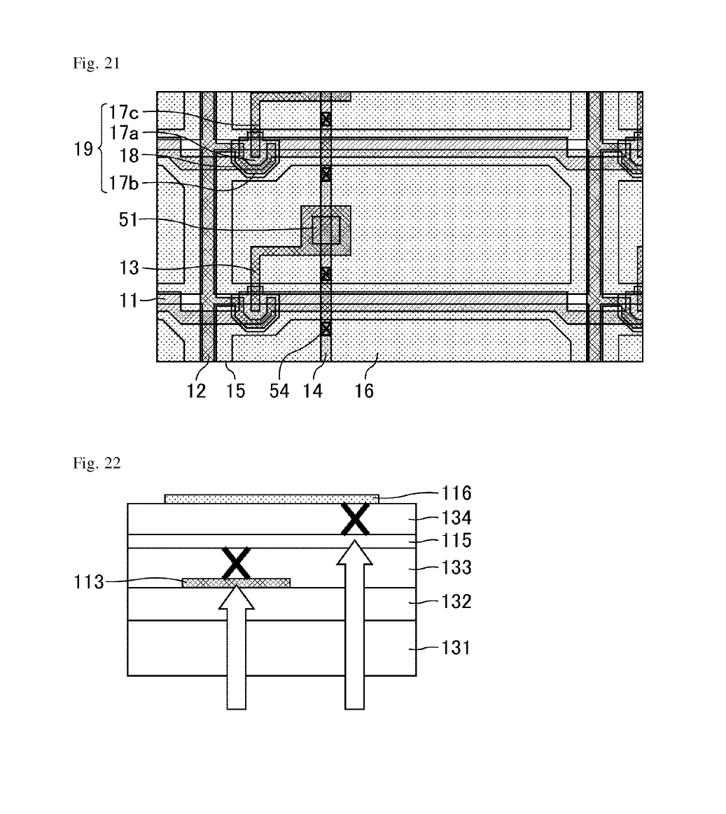

FIG. 21 is a schematic plan view of the active matrix substrate of Embodiment 8. The auxiliary capacitance wiring 14 is formed not along the drawing direction of the gate bus lines 11, but along the drawing direction of the source bus lines 12 as shown in FIG. 21.

In Embodiment 8, the gate electrode 17a of each TFT 19 is extended from the gate bus line 11. The source bus line 12 is partly branched, and the branch part is connected to the source electrode 17b of the TFT 19. The drain lead-out wiring 13 is extended from the drain electrode 17c of the TFT 19 along the drawing direction of the source bus lines 12. The drain lead-out wiring 13 partly bends and extends toward the center of the pixel, but it does not reach the center of the pixel. The end of the drain lead-out wiring 13 has a large area. The drain lead-out wiring 13 is connected to the corresponding pixel electrode 16 through the contacting portion 51 penetrating the second insulating film 33 and the third insulating film 34.

In Embodiment 8, the auxiliary capacitance wiring 14 and the gate bus lines 11 are formed in the same layer except at intersections thereof. At the intersections, the auxiliary capacitance wiring 14 is extended to the layer including the source bus lines 12 through the contacting portions 54 formed in the insulating film. The part of the auxiliary capacitance wiring 14 located in the same layer as the gate bus lines 11 is formed from the same material as the gate bus lines 11, and the part located in the same layer as the source bus lines 12 is formed from the same material as the source bus lines 12.

In Embodiment 8, the auxiliary capacitance wiring 14 crosses the large-area portions of the drain lead-out wirings 13. Due to this structure of the liquid crystal display panel of Embodiment 8, laser irradiation of the auxiliary capacitance wiring 14 overlapping with any of the drain lead-out wirings 13 allows the auxiliary capacitance wiring 14 to be connected to the drain lead-out wiring 13. Thereby, the repaired pixel appears black, eliminating the bright spot.

Thus, the CPA mode (including modified version) liquid crystal display panels are described in Embodiments 1 to 4, and the FFS mode liquid crystal display panels are described in Embodiments 5 and 6, and the TN mode liquid crystal display panels are described in Embodiments 7 and 8. Characteristics of these embodiments and variations thereof may be appropriately combined to provide benefits based on the respective characteristics.

The present application claims priority to Patent Application No. 2011-175464 filed in Japan on Aug. 10, 2011 under the Paris Convention and provisions of national law in a designated State, the entire contents of which are hereby incorporated by reference.

### REFERENCE SIGNS LIST

10: active matrix substrate
11: gate bus line (scan signal line)
12: source bus line (data signal line)
13, 113: drain lead-out wiring
14: auxiliary capacitance wiring
15, 115: transparent auxiliary capacitance (Cs) electrode
16, 116: pixel electrode
16a: slit of pixel electrode
17a: gate electrode
17b: source electrode
17c: drain electrode
18: semiconductor layer
19: thin film transistor (TFT)
20: counter substrate
21, 31, 131: glass substrate
22: common electrode
23: rivet
24, 35: alignment film
25: rivet or hole
32, 132: gate insulating film (first insulating film)
33, 133: second insulating film
34, 134: third insulating film
40: liquid crystal layer
51, 52, 53, 54: contacting portion

1. A liquid crystal display panel, comprising:
a first substrate comprising an insulating substrate, a thin film transistor, a scan signal line, a first light-shielding electrode, a first insulating film, a second light-shielding electrode, a second insulating film, a transparent electrode, a third insulating film, and a pixel electrode;
a second substrate comprising an insulating substrate; and
a liquid crystal layer sandwiched between the first substrate and the second substrate,
the second light-shielding electrode being located between the thin film transistor and the pixel electrode and connected to the pixel electrode through a connecting portion formed through the second insulating film and the third insulating film,
the first light-shielding electrode at least partly overlapping with the second light-shielding electrode with the first insulating film therebetween, and
the transparent electrode being in a layer closer to the liquid crystal layer than both a layer including the scan signal line and a layer including the second light-shielding electrode are.

2. The liquid crystal display panel according to claim 1,
wherein the transparent electrode is a common electrode, the common electrode and the pixel electrode generating an electric field in the liquid crystal layer between these electrodes, and
a potential supplied to the first light-shielding electrode is the same as a potential supplied to the transparent electrode.

3. The liquid crystal display panel according to claim 1 which is a normally black liquid crystal display panel,
wherein the second substrate has a common electrode, and
a potential supplied to the first light-shielding electrode is the same as a potential supplied to the common electrode.

4. The liquid crystal display panel according to claim 1 which is a normally white liquid crystal display panel,
wherein the second substrate has a common electrode,
a potential supplied to the first light-shielding electrode is different from a potential supplied to a common potential.

5. The liquid crystal display panel according to claim 1,
wherein the first light-shielding electrode extends substantially parallel to the scan signal line and is in the same layer as the scan signal line.

6. The liquid crystal display panel according to claim 1,
further comprising a data signal line,
wherein the first light-shielding electrode extends substantially parallel to the data signal line and has a portion located in the same layer as the data signal line and a portion located in the same layer as the scan signal line.

7. The liquid crystal display panel according to claim 1,
wherein the first light-shielding electrode and the second light-shielding electrode have an overlapping region comprising a region of at least 5 μm square.
